(19) United States
(12) Patent Application Publication
(10) Pub. No.: US 2026/0086350 A1
(43) Pub. Date: Mar. 26, 2026

(54) MICROMIRROR DEVICE DESIGN WITH TILT CONTROL ELECTRODES

(71) Applicant: TEXAS INSTRUMENTS INCORPORATED, Dallas, TX (US)

(72) Inventors: William Craig McDONALD, Allen, TX (US); Jacky D. GRIMMETT, Prosper, TX (US); James Norman HALL, Parker, TX (US)

(21) Appl. No.: 18/893,383

(22) Filed: Sep. 23, 2024

(51) Int. Cl. G02B 26/08

(52) U.S. Cl. CPC G02B 26/0841

(57) ABSTRACT

In some examples, a device includes a mirror. The device also includes first and second mirror bias electrodes disposed on a substrate, the mirror electrically coupled to the first and second mirror bias electrodes. The device also includes first and second address electrodes on the substrate between the first and second mirror bias electrodes. The device also includes first and second outer tilt bias electrodes on the substrate, the first and second address electrodes between the first and second outer tilt bias electrodes.

### BACKGROUND

MEMS may be used for visible wavelength applications such as static or dynamic images, high dynamic range (HDR) video, virtual displays, augmented reality displays, and automobile headlights. In ultraviolet portions of the spectrum, MEMS may be used for lithography or three-dimensional (3D) printing. In infrared portions of the spectrum, MEMS may be used for telecommunications or ranging applications. Some MEMS modulate light by moving mirrors to one of a series of discrete positions.

### SUMMARY

In some examples, a device includes a mirror. The device also includes first and second mirror bias electrodes on a substrate, the mirror electrically coupled to the first and second mirror bias electrodes. The device also includes first and second address electrodes on the substrate between the first and second mirror bias electrodes. The device also includes first and second outer tilt bias electrodes on the substrate, the first and second address electrodes between the first and second outer tilt bias electrodes.

In some examples, a device includes a mirror. The device also includes first and second mirror bias electrodes on a substrate, the mirror coupled to the first and second mirror bias electrodes. The first and second mirror bias electrodes are configured to provide a mirror bias voltage to the mirror. The device also includes an inner bias electrode on the substrate between the first and second mirror bias electrodes. The inner bias electrode is configured to receive a bias voltage. The device also includes first and second address electrodes on the substrate between the first and second mirror bias electrodes. The first and second address electrodes are configured to receive first and second respective address voltages to modify an electrostatic force between the mirror and the first and second address electrodes to cause the mirror to tilt to a tilt angle. The inner bias electrode is on the substrate between the first and second address electrodes.

In some examples, a device includes a substrate, an electrode layer on the substrate, a via layer, a hinge layer, and a mirror. The electrode layer includes a first electrode, a second electrode, a third electrode between the first electrode and the second electrode, a fourth electrode between the first electrode and the second electrode, a fifth electrode, and a sixth electrode. The third electrode and the fourth electrode are between the fifth electrode and the sixth electrode. The via layer includes a first via on the first electrode, a second via on the second electrode, a third via on the third electrode, and a fourth via on the fourth electrode. The hinge layer includes a hinge on the first via and the second via, a first raised electrode on the third via, and a second raised electrode on the fourth via. A fifth via couples the mirror and the hinge.

### BRIEF DESCRIPTION OF THE DRAWINGS

FIG. 1 is a block diagram of an example system.

FIG. 2 is a block diagram of a top-down view of an example DMD.

FIG. 3 is a block diagram of a top-down view of an example block of the DMD.

FIG. 4A is an exploded view of an example micromirror device.

FIG. 4B is a top-down view of the example micromirror device.

FIG. 4C is a top-down view of a substrate and electrodes of the example micromirror device.

FIG. 4D is a block diagram of a view across the example micromirror device.

FIG. 5A is a block diagram of a view across the example micromirror device illustrating a tilt angle.

FIG. 5B is a block diagram of a view across the example micromirror device illustrating a tilt angle.

FIG. 5C is a block diagram of a view across the example micromirror device illustrating a tilt angle.

FIG. 6A is an exploded view of an example micromirror device.

FIG. 6B is a top-down view of the example micromirror device.

FIG. 6C is a top-down view of a substrate and electrodes of the example micromirror device.

FIG. 6D is a block diagram of a view across the example micromirror device.

FIG. 7A is a block diagram of a view across the example micromirror device illustrating a tilt angle.

FIG. 7B is a block diagram of a view across the example micromirror device illustrating a tilt angle.

FIG. 7C is a block diagram of a view across the example micromirror device illustrating a tilt angle.

FIG. 8 is a flowchart of an example method for control of a micromirror device.

FIG. 9 is a flowchart of an example method for control of a micromirror device.

FIG. 10 is a diagram of tilt angles of an example micromirror device.

FIG. 11 is a top-down view of another example micromirror device.

FIG. 12 is a top-down view of another example micromirror device.

FIG. 13A is a top-down view of another example micromirror pixel.

FIG. 13B is a top-down view of a hinge layer of the micromirror pixel of FIG. 13A.

FIG. 13C is a top-down view of an electrode layer and substrate of the micromirror pixel of FIG. 13A.

FIG. 13D is an exploded view of the micromirror pixel of FIG. 13A.

FIG. 14A is a top-down view of another example micromirror pixel.

FIG. 14B is a top-down view of a hinge layer of the micromirror pixel of FIG. 14A.

FIG. 14C is a top-down view of an electrode layer and substrate of the micromirror pixel of FIG. 14A.

FIG. 14D is an exploded view of the micromirror pixel of FIG. 14A.

FIG. 15A is a top-down view of another example micromirror pixel.

FIG. 15B is a top-down view of a hinge layer of the micromirror pixel of FIG. 15A.

FIG. 15C is a top-down view of an electrode layer and substrate of the micromirror pixel of FIG. 15A.

FIG. 15D is an exploded view of the micromirror pixel of FIG. 15A.

FIG. 16A is a top-down view of another example micromirror pixel.

FIG. 16B is a top-down view of a hinge layer of the micromirror pixel of FIG. 16A.

FIG. 16C is a top-down view of an electrode layer and substrate of the micromirror pixel of FIG. 16A.

FIG. 16D is an exploded view of the micromirror pixel of FIG. 16A.

### DETAILED DESCRIPTION

One example of a MEMS is a digital micromirror device (DMD). A DMD may include mirrors arranged in an array, such as a rectangular (or square) array. Each of the mirrors may uniquely correspond to an individual pixel of an image which the DMD may be controlled to display. The DMD may be controlled, such as by a controller, to individually tilt the mirrors to redirect light that is directed at the DMD by a light source. For example, specific voltages may be applied to an electrode or multiple electrodes to cause a mirror to tilt or rotate between an on position or a complementary off position. In an example, the DMD may tilt the mirror in a first direction to place the mirror in the on position. In the on position, the mirror may reflect light directed at the DMD from the light source into a lens to cause a corresponding pixel to appear bright on a display surface. In another example, the DMD may tilt the mirror in a second direction, which may be opposite to the first direction, to place the mirror in the off position. In the off position, the mirror may reflect light directed at the DMD from the light source away from the lens to cause the corresponding pixel to appear dark on the display surface.

In an example, the DMD creates an electrostatic force between the mirror and the electrode(s) to control a position (e.g., tilt angle) of the mirror. The mirror may be electrically and mechanically coupled, such as through vias or other conductive rigid structures, to a hinge layer. In some examples, the hinge layer includes a hinge such as a torsion hinge that has a fixed position at each end and is capable of twisting along the length of the hinge between the ends of the hinge to cause the mirror to tilt in a direction of that twisting. The hinge layer may also include spring tips mechanically and electrically coupled to the hinge. The spring tips are semi-rigid structures that provide mechanical stops to define a landed position for the mirror. Thus, the tilt angle may be at least partially determined according to a location of the spring tips. However, the flexibility of the spring tips resulting from their semi-rigid nature may allow fine control over the final tilt angle (e.g., the landed or steady state tilt angle for a given set of control inputs) based on an electrostatic force between the mirror and the electrode(s).

To control a position of the mirror, electrodes of the DMD are energized, or de-energized, to manipulate the electrostatic force between the mirror and the electrode. In an example, an electrode is energized by providing a signal having a non-zero voltage to that respective electrode and de-energized by providing a signal having a voltage of approximately zero to that respective electrode. For example, a first voltage may be provided to a first electrode positioned on a first side of the hinge. A second voltage that is complementary to the first voltage may be provided to a second electrode positioned on a second side of the hinge. In one example, the first voltage may be approximately equal to 1.8 volts (V) and a second voltage may be approximately equal to 0 V. In some examples, the first and second electrodes may be electrically and mechanically coupled through vias to corresponding first and second raised electrodes that are approximately co-planar with the hinge. In some examples, the first and second raised electrodes may be said to be included in the hinge layer. Resulting from their electrical coupling, the first and second raised electrodes will have substantially a same electrical potential as the first and second electrodes, respectively. Therefore, the first raised electrode and the first electrode are referred to herein collectively as the first electrode. Similarly, the second raised electrode and the second electrode are referred to herein collectively as the second electrode. The hinge may be electrically and mechanically coupled to third and fourth electrodes through vias. For example, at the first end of the hinge, the hinge may be coupled to the third electrode through one or more vias and at the second end of the hinge, the hinge may be coupled to the fourth electrode through one or more vias. A third voltage is applied to the mirror by way of the third and fourth electrodes to provide a voltage bias at the mirror. In one example, the third voltage may be approximately equal to 21 V.

By modifying values of the first voltage and the second voltage, the mirror may be repositioned, or tilted, to an angle corresponding to the values of the first voltage and the second voltage. For example, by modifying values of the first voltage and the second voltage, electrostatic attraction or deflection between the first electrode, the second electrode, and the mirror may be altered. By increasing the electrostatic attraction between the mirror and one of the first or second electrodes, the mirror tilts in the direction of that one of the first or second electrode until the mirror comes to rest on at least some of the spring tips. The electrostatic attraction may increase as a voltage differential between the third voltage and the first voltage or the second voltage increases. Said another way, the mirror may tilt in the direction of one of the first or second electrodes which is biased with a voltage having a greater voltage differential with respect to the third voltage than does the other of the first or second electrodes. For example, if the third voltage minus the first voltage is greater than the third voltage minus the second voltage, the mirror may tilt toward the electrode that is biased according to the first voltage. Any combination of the first voltage, the second voltage, and the third voltage may be provided to the DMD by a controller coupled to the DMD. In some examples, the controller may load or store values of the first voltage and the second voltage in a memory, such as a static random-access memory (SRAM) cell. The SRAM cell may be coupled to the first and second electrodes to provide the first voltage and the second voltage (e.g., address voltages) to the first and second electrodes, respectively, to control a position of the mirror.

In some examples, variation in manufacturing process control and tolerances may cause variation in a tilt angle of a first mirror of the DMD and a second mirror of the DMD responsive to the same value of the first voltage, the second voltage, and the third voltage. Extrapolated across a DMD of tens, hundreds, or thousands or mirrors, this variation in tilt angle may cause an image provided based on light reflected by the DMD to have less precision than in the absence of the variation, or in the presence of a reduced amount of variation. For some application environments, such as mask-less lithography systems or other applications based on high f/number optical systems, the variation and resulting lack of precision may render the DMD unsuitable for use in those application environments.

Examples of this description include a DMD including one or more tilt bias, or tilt control, electrodes. The tilt bias electrode(s) may enable adjustment, refinement, or other tuning of the tilt angle of the mirror independent of the first voltage, the second voltage, or the third voltage. For example, without a change to any of the first voltage, the second voltage, or the third voltage, the tilt angle of the mirror may be modified responsive to a change in value of a bias voltage provided to the tilt bias electrode(s). By enabling modification of the tilt angle independent of a programmed value for the tilt angle, such as provided by way of the first voltage and the second voltage, variation in the tilt angle of one or more mirrors of the DMD from a tilt angle corresponding to the programmed value may be mitigated. In some examples, the tilt bias may be applied on a per mirror or per pixel basis. In other examples, a same tilt bias may be applied to multiple mirrors or pixels of a DMD, where the mirrors are in a contiguous group (e.g., a block) or non-contiguous group. In yet other examples, a same tilt bias may be applicated to multiple DMD devices.

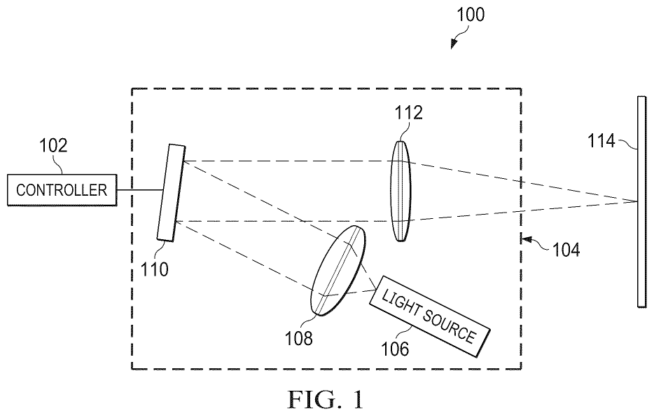

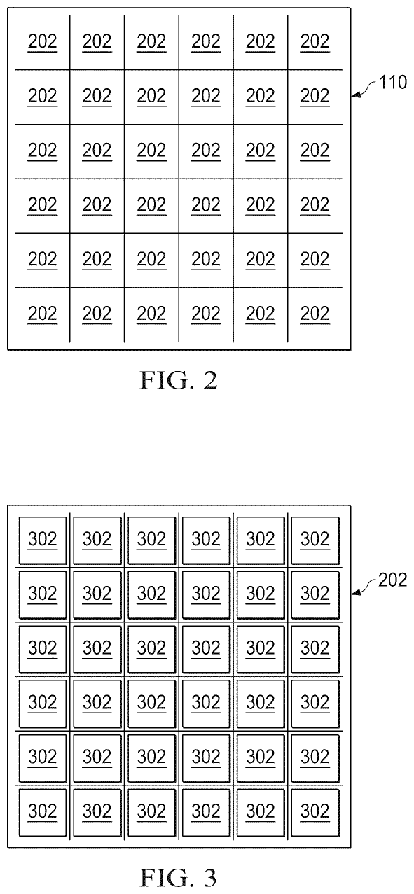

FIG. 1 is a block diagram of an example system 100. In some examples, the system 100 is any suitable system for projecting an image with a DMD, such as described herein. System 100 includes a controller 102, a display device 104, and a projection surface 114. The display device includes a light source 106, focusing optics 108, a DMD 110, and projection optics 112. Focusing optics 108 and projection optics 112 may each include multiple elements, including multiple lenses and other optical elements, in some examples. As shown in FIG. 2, which is a block diagram of a top-down view of an example DMD 110, the DMD 110 may include multiple blocks 202. Although shown as including an array of 36 blocks of approximately equal size, the DMD 110 may include any number of blocks of any size or arrangement. As shown in FIG. 3, which is a block diagram of a top-down view of an example block 202 of the DMD 110, the block 202 may include multiple micromirror pixels 302. Although shown as including an array of 36 micromirror devices of approximately equal size, the block 202 may include any number of micromirror devices of any size or arrangement. Returning to FIG. 1 with continued reference to FIG. 2 and FIG. 3, system 100 may be a projection system for viewing images or video, in one example. In another example, system 100 may be a system for projecting images from an automobile onto a surface outside of the automobile. In another example, system 100 may be an augmented reality HUD in an automobile. The HUD may display various information to the driver or other passengers in the automobile. System 100 may be used for automotive headlights, in another example. System 100 may be a wearable device or system, such as an augmented reality or virtual reality device. In another examples, system 100 may be an industrial system for lithography, such as mask-less lithography, three-dimensional (3D) printing, or other applications based on high f/number optics.

Light source 106 is configured to project light through focusing optics 108 to DMD 110. Light source 106 may be a laser in one example. In other examples, light source 106 may be a light emitting diode. In yet other examples, light source 106 may be a laser phosphor source. A different source of light may be used in the light source 106 in other examples. Controller 102 controls electrodes (not shown) of DMD 110 in the manner described elsewhere herein. Controller 102 may be any suitable controller or processor that provides signals to each electrode of DMD 110 either directly, or via a memory (not shown). Controller 102 may also be coupled (although not shown) to light source 106 in some examples and may control light source 106. Controller 102 may control the electrodes of DMD 110 via an array of memory cells, for example an SRAM memory array (not shown) of the DMD 110 in one example. Voltages are applied to the electrodes of DMD 110 as described herein to create an electrostatic force that moves micromirror pixels 302 of DMD 110. Movement of the micromirror pixels 302 redirects the light from light source 106 toward (for corresponding bright pixels on the projection surface 114) or away (for corresponding dark pixels on the projection surface 114) from the projection optics 112. Redirection of the light from light source 106 therefore produces images, which may pass through projection optics 112 to projection surface 114. In some examples, projection optics 112 may be absent. Projection surface 114 may be a surface inside an automobile, such as a windshield, a surface outside of the automobile, such as the ground, a wall, a screen, a semi-transparent surface, a substrate or component of a lithography process, etc.

In some examples, a tilt bias voltage may be applied to the micromirror pixels 302. The tilt bias voltage may be applied on a per mirror basis such that each micromirror pixel 302 receives its own independent tilt bias voltage, on a group basis in which a first grouping of micromirror pixels 302 of the block 202 receive a first tilt bias voltage and a second grouping of micromirror pixels 302 of the block 202 receive a second tilt bias voltage, on a per block basis in which each micromirror pixel 302 of a particular block 202 receives the same tilt bias voltage, on a group basis in which micromirror pixels 302 of a first grouping of blocks 202 receive a first tilt bias voltage and micromirror pixels 302 of a second grouping of blocks 202 receive a second tilt bias voltage, or a device basis in which all micromirror pixels 302 of the DMD 110 receive a same tilt bias voltage. Generally, the tilt bias voltage may have a value determined according to a variance of a tilt angle of a micromirror pixel 302 from a nominal tilt angle given a particular set of control signals provided to the micromirror pixel 302, where the value of the tilt bias voltage is determined to decrease the variance. In some examples in which multiple micromirror pixels 302 receive a same tilt bias voltage, a value of the tilt bias voltage may be determined according to an average variance of a tilt angle of the micromirror pixels 302 from a nominal tilt angle given a particular set of control signals provided to the micromirror pixels 302. By decreasing the variance of the tilt angle of the micromirror pixel(s) 302 from the nominal tilt angle given the particular set of control signals provided to the micromirror pixel(s) 302, precision of an image produced via light reflection by the micromirror pixels 302 of the DMD 110 may be increased. The increase in precision may render the DMD 110 suitable for use in application environments in which the DMD 110 might otherwise not be suitable for in the absence of the increase in precision resulting from the tilt bias control of the micromirror pixels 302.

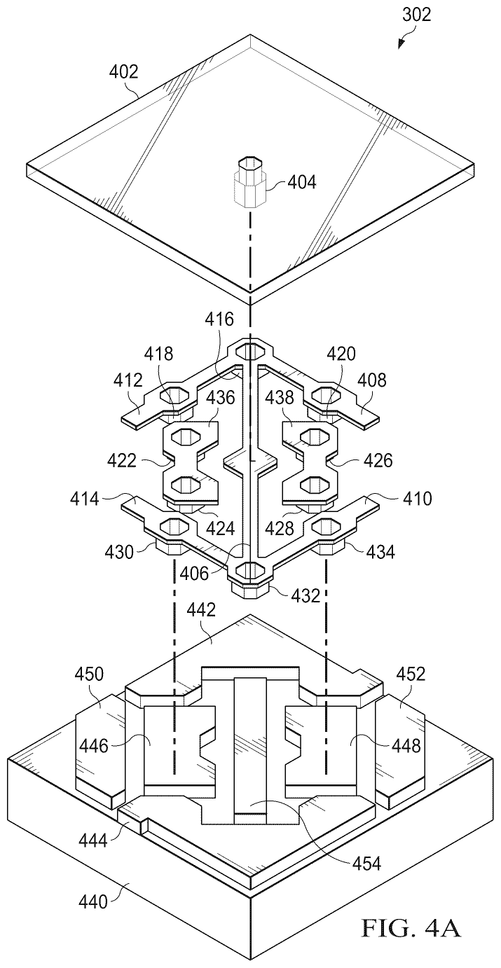

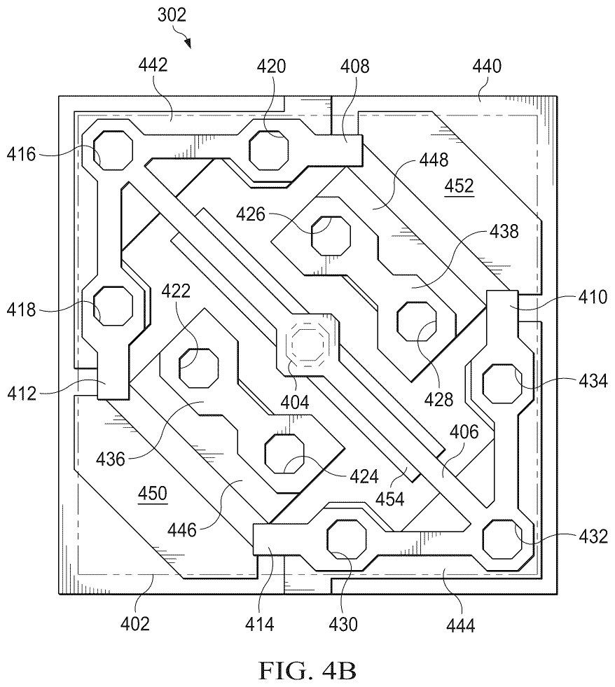

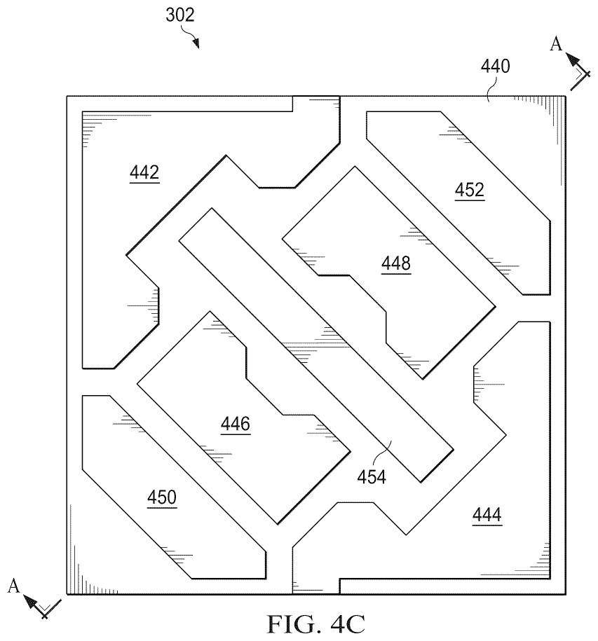

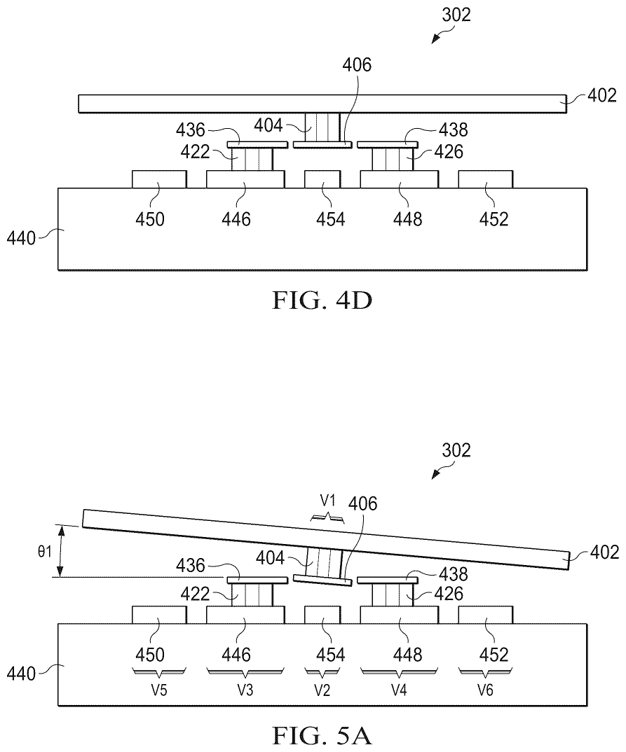

FIG. 4A is an exploded view of an example micromirror pixel 302. FIG. 4B is a corresponding top-down view of the example micromirror pixel 302 of FIG. 4A, and FIG. 4C is a corresponding top-down view of the substrate 440 and electrodes 442-454 of the example micromirror pixel 302 of FIGS. 4A and 4B. FIG. 4D is a corresponding block diagram of a view across the example micromirror pixel 302 of FIGS. 4A-4C from line AA. FIG. 4D omits portions of the micromirror pixel 302, including at least the electrodes 442, 444 and portions of the hinge 406, for clarity and to aid in illustrating a vertical relationship among the components of the micromirror pixel 302. In an example, the micromirror pixel 302 includes a mirror 402, a hinge layer including hinge 406 and spring tips 408, 410, 412, 414, a via layer including vias 416, 418, 420, 422, 424, 426, 428, 430, 432, 434, and a substrate 440 upon which an electrode layer is disposed including electrodes 442, 444, 446, 448, 450, 452, and 454. In some examples, electrodes 446 and 448 have corresponding raised electrodes 436 and 438. In an example, the hinge layer includes the raised electrodes 436 and 438. The mirror 402 is mechanically and electrically coupled to the hinge 406 through a via 404. In some examples, the hinge 406 may be a torsion hinge such that the mirror 402 may tilt or rotate about a center axis of the hinge 406 running lengthwise through the hinge 406. The hinge 406 is mechanically and electrically coupled to the electrode 442 through the vias 416, 418, 420. Thus, the mirror 402 may be mechanically and electrically coupled to the electrode 442 by way of the via 404, hinge 406, and vias 416, 418, 420. The hinge 406 is mechanically and electrically coupled to the electrode 444 through the vias 430, 432, 434. Thus, the hinge 406 may be mechanically and electrically coupled to the electrode 444 by way of the via 404, hinge 406, and vias 430, 432, 434. The raised electrode 436 is mechanically and electrically coupled to the electrode 446 through vias 422, 424. The raised electrode 438 is mechanically and electrically coupled to the electrode 448 through vias 426, 428. In some examples, the substrate 440 includes complementary metal-oxide-semiconductor (CMOS) circuitry, such as memory (e.g., SRAM) cells for a respective micromirror pixel. In an example, the electrodes 446, 448 are located on the substrate 440 between the electrodes 442, 444. In the same example, the electrodes 446, 448 are also located on the substrate 440 between the electrodes 450, 452. In the same example, the electrode 454 is located on the substrate 440 between the electrodes 446, 448.

In an example, the electrodes 442 and 444 may be referred to as mirror bias electrodes. The electrodes 442 and 444 may be energized to provide a bias voltage at the mirror 402. In some examples, the bias voltage may be about 21 V. The electrodes 446, 448 may be referred to as address electrodes. The electrodes 446, 448 may be energized, or de-energized, to provide address voltages. The address voltages may correspond to particular programmed or nominal tilt angles for the mirror 402 corresponding to those particular address voltages. In some examples, the address voltages provided to the electrodes 442 and 444 may be complementary voltages. In an example, complementary voltages include a first voltage having a value representative of a logical high value and a second voltage having a value representative of a logical low value. Examples of complementary voltages can include 1.8 V and 0 V, 2.5 V and 0 V, 3.3 V and 0 V, or any other pair of voltages suitable for an application environment of the micromirror pixel 302. The electrodes 450, 452 may be referred to as outer tilt bias electrodes. The electrodes 450, 452 may be energized, or de-energized, to increase or decrease the tilt angle of the mirror 402. For example, an increased tilt angle of the mirror 402 results in increased spring tip deflection by one or more of the spring tips 408, 410, 412, 414 and a decreased tile angle of the mirror 402 results in increase hinge sag of the hinge 406. In some examples, such increase or decrease occurs without a corresponding change to the bias voltage provided at the mirror 402 or the address voltages. The electrode 454 may be referred to as an inner tilt bias electrode or inner electrode. The electrode 454 may be energized, or de-energized, to increase or decrease the tilt angle of the mirror 402. In some examples, such increase or decrease occurs without a corresponding change to the bias voltage provided at the mirror 402 or the address voltages. As a voltage differential between a value of the bias voltage provided at the mirror 402 and an electrode of the micromirror pixel 302 increases, the mirror 402 may be drawn via electrostatic attraction toward that respective electrode. By way of the hinge 406 and spring tips 408, 410, 412, 414, this electrostatic attraction causes the mirror 402 to tilt in the direction of the respective electrode to which the mirror 402 is being drawn.

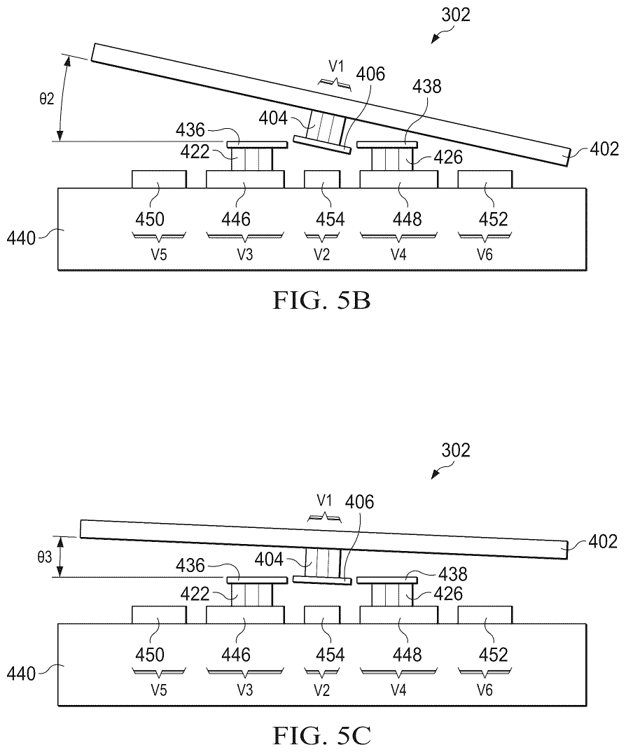

FIGS. 5A, 5B, and 5C are block diagrams of a view across the example micromirror pixel 302 of FIG. 4D illustrating various tilt angles. As shown in FIG. 5A, a voltage V1 is applied to the mirror 402, a voltage V2 is applied to the electrode 454, a voltage V3 is applied to the electrode 446, a voltage V4 is applied to the electrode 448, a voltage V5 is applied to the electrode 450, and a voltage V6 is applied to the electrode 452. Responsive to V1 having a first value, V3 having a second value, and V4 having a third value, a resulting electrostatic force between the mirror 402 and the electrode(s) 436, 438, 446, 448 causes the mirror 402 to tilt to an angle of Θ1 and come to rest on a spring tip (not shown) of the micromirror pixel 302. For example, as shown in FIG. 5A, the combination of values of V1, V2, V3, and V4 causes an electrostatic force between the mirror 402 and the raised electrode 438 to increase to an amount greater than between the mirror 402 and the raised electrode 436. Accordingly, the mirror 402 tilts toward the raised electrode 438. In some examples, in FIG. 5A, V2 has a value approximately equal to V1. In some examples, V1 has a value approximately equal to 21 V, V3 has a value approximately equal to 1.8 V, and V4 has a value approximately equal to 0 V. In the example of FIG. 5A, V5 and V6 have a value of approximately equal to 0 V.

As shown in FIG. 5B, responsive to a change in value of V5 and/or V6, a resulting electrostatic force between the mirror 402 and the electrode(s) 436, 438, 446, 448, 450, 452, 454 causes the mirror 402 to tilt to an angle of Θ2, where Θ2>Θ1. For example, an electrostatic force between the mirror 402 and the electrode 452 increases, causing the tilt angle of the mirror 402 to increase in the direction of the electrode 452. The increased tilt angle of the mirror 402 in FIG. 5B results in increased deflection of a spring tip on which the mirror 402 rests. In some examples, the change in tilt angle of the mirror 402 to Θ2 occurs without a change to V1, V2, V3, or V4. In some examples, V5 and V6 have a value of approximately −4 V. While shown as being approximately equal in value, in some examples V5 and V6 may have values that are not approximately equal. As another example suitable for causing the increased tilting shown in FIG. 5B, V5 may have any suitable value greater than −4 V and V6 may have a value of about −4 V.

As shown in FIG. 5C, responsive to a change in value of V2, a resulting electrostatic force between the mirror 402 and the electrode(s) 436, 438, 446, 448, 450, 452, 454 causes the mirror 402 to tilt to an angle of Θ3, where Θ1>Θ3. For example, an electrostatic force between the mirror 402 and the electrode 454 increases, causing the tilt angle of the mirror 402 to decrease. The decreased tilt angle of the mirror 402 in FIG. 5C results in increased sag of the hinge 406 to which the mirror 402 is coupled. In some examples, the change in tilt angle of the mirror 402 to Θ3 occurs without a change to V1, V3, V4, V5, or V6. In some examples, V2 as shown in FIG. 5C has a value of approximately 6 V. In other examples, responsive to a change in value of V5 and/or V6, and without a corresponding change in value of V2, a resulting electrostatic force between the mirror 402 and the electrode(s) 436,438, 446, 448, 450, 452, 454 causes the mirror to tilt to the angle of Θ3, where Θ1>Θ3. In such an example, at least one of V5 or V6 may have a value greater than 0 V.

Although certain example voltages are described with respect to FIGS. 5A-5C, in application other voltages may be used. In some examples, performance of the micromirror pixel 302 may be measured and the voltages determined based on that measuring. For example, a variance of Θ1 from a nominal value for Θ1 may first be determined. Subsequently, various values of V2, V5, and V6 may be tested to determine an effect on the tilt angle of the micromirror pixel 302 resulting from the various combinations of tested values of V2, V5, and V6. Thus, a mapping may be determined between values of V2, V5, and V6 and corresponding approximate tilt angles of the micromirror pixel 302. In some examples, Θ2 and Θ3 are within about 1 degree of Θ1. For example, Θ2 and Θ3 may be within about 0.5 degree of Θ1. Thus, in such an example, the tilt angle of the mirror 402 may be increased or decreased from Θ1 by approximately 0.5 degree based on values of bias voltages provided at the electrodes 450, 452, 454.

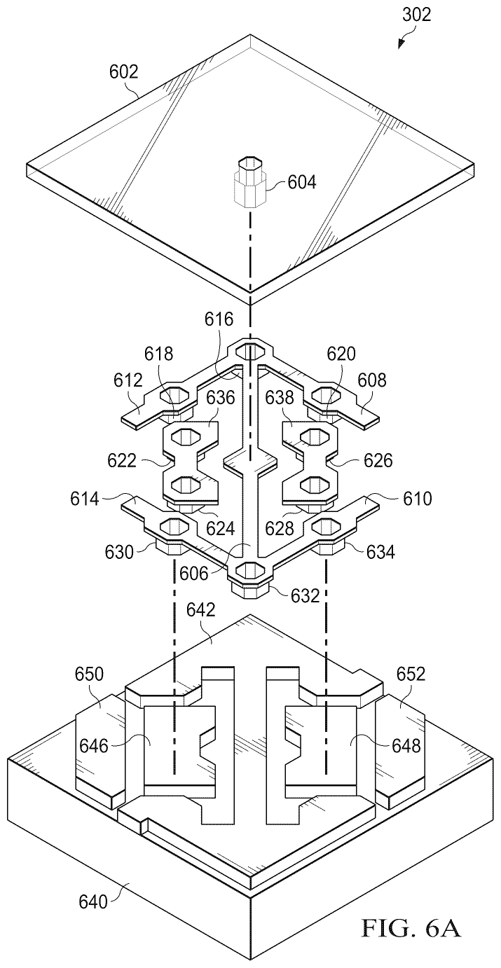

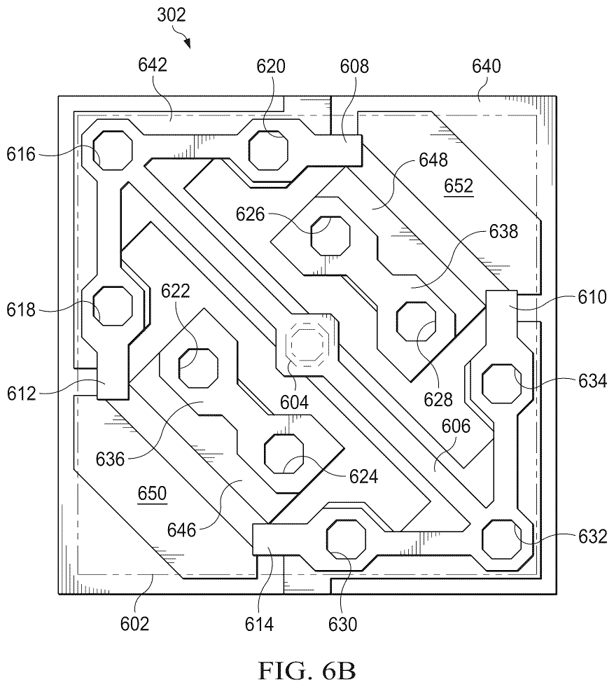

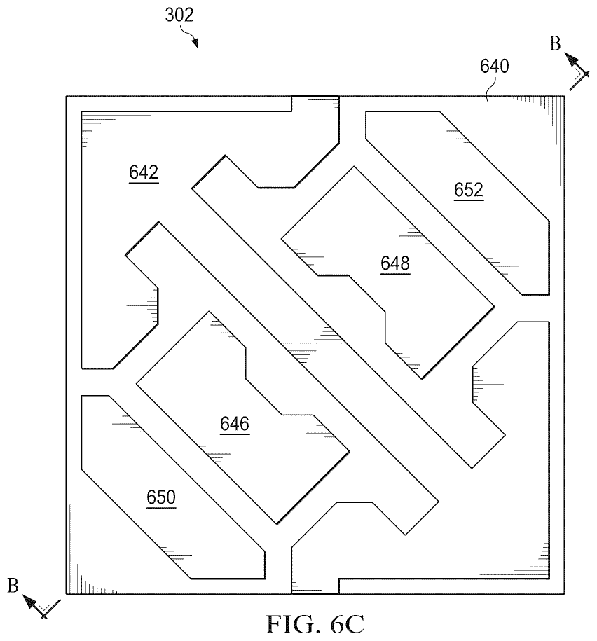

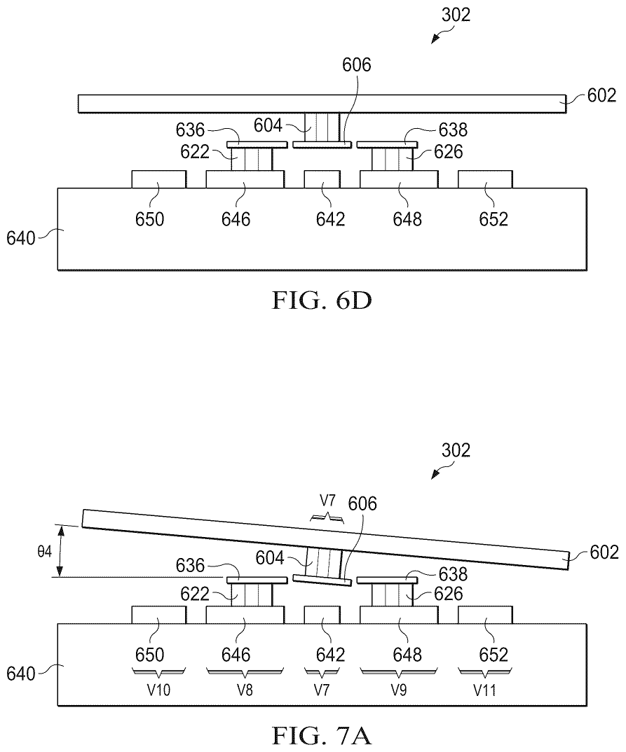

FIG. 6A is an exploded view of another example micromirror pixel 302. FIG. 6B is a corresponding top-down view of the example micromirror pixel 302 of FIG. 6A, and FIG. 6C is a corresponding top-down view of the substrate 640 and electrodes 642 and 646-652 of the example micromirror pixel 302 of FIGS. 6A and 6B. FIG. 6D is a corresponding block diagram of a view across the micromirror pixel 302 of FIGS. 6A-6C from line BB. FIG. 6D omits portions of the micromirror pixel 302, including at least the electrode 642 and portions of the hinge 606, for clarity and to aid in illustrating a vertical relationship among the components of the micromirror pixel 302. In an example, the micromirror pixel 302 includes a mirror 602, a hinge layer including hinge 606 and spring tips 608, 610, 612, 614, a via layer including vias 616, 618, 620, 622, 624, 626, 628, 630, 632, 634, and a substrate 640 upon which an electrode layer is disposed including electrodes 642, 646, 648, 650, and 652. In some examples, electrodes 646 and 648 have corresponding raised electrodes 636 and 638. In an example, the hinge layer includes the raised electrodes 636 and 638 The mirror 602 is mechanically and electrically coupled to the hinge 606 through a via 604. In some examples, the hinge 606 may be a torsion hinge such that the mirror 602 may tilt or rotate about a center axis of the hinge 606 running lengthwise through the hinge 606. The hinge 606 is mechanically and electrically coupled to the electrode 642 through the vias 616, 618, 620, 630, 632, 634. Thus, the mirror 602 may be mechanically and electrically coupled to the electrode 642 by way of the via 604, hinge 606, and vias 616, 618, 620, 630, 632, 634. The raised electrode 636 is mechanically and electrically coupled to the electrode 646 through vias 622, 624. The raised electrode 638 is mechanically and electrically coupled to the electrode 648 through vias 626, 628. In some examples, the substrate 640 includes CMOS circuitry, such as memory (e.g., SRAM) cells for a respective micromirror pixel. In an example, the electrodes 646, 648 are located on the substrate 640 between portions of the electrodes 642, with the electrode 642 also having a portion located on the substrate 640 between the electrodes 646, 648. In the same example, the electrodes 646, 648 are also located on the substrate 640 between the electrodes 650, 652.

In an example, the electrode 642 may be referred to as a mirror bias electrode. The electrode 642 may be energized to provide a bias voltage at the mirror 602. In some examples, the bias voltage may be about 21 V. The electrodes 646, 648 may be referred to as address electrodes. The electrodes 646, 648 may be energized, or de-energized, to provide address voltages. The address voltages may correspond to particular programmed or nominal tilt angles for the mirror 602 corresponding to those particular address voltages. In some examples, the address voltages provided to the electrode 646, 648 may be complementary voltages. The electrodes 650, 652 may be referred to as outer tilt bias electrodes. The electrodes 650, 652 may be energized, or de-energized, to increase or decrease the tilt angle of the mirror 602. For example, an increased tilt angle of the mirror 402 results in increased spring tip deflection by one or more of the spring tips 408, 410, 412, 414 and a decreased tile angle of the mirror 402 results in increase hinge sag of the hinge 406. In some examples, such increase or decrease occurs without a corresponding change to the bias voltage provided at the mirror 602 or the address voltages. As a voltage differential between a value of the bias voltage provided at the mirror 602 and a respective electrode of the micromirror pixel 302 increases, the mirror 602 may be drawn via electrostatic attraction toward that respective electrode. By way of the hinge 606 and spring tips 608, 610, 612, 614, this electrostatic attraction causes the mirror 602 to tilt in the direction of the respective electrode to which the mirror 602 is being drawn.

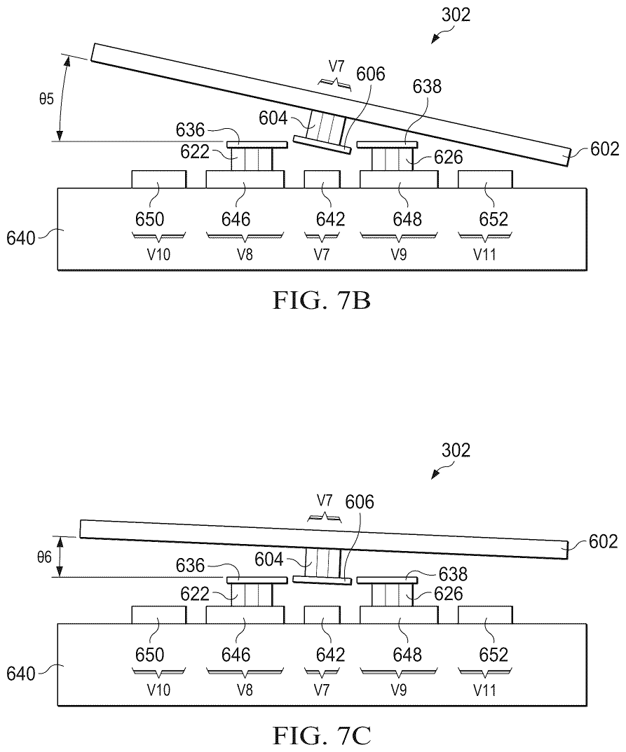

FIGS. 7A, 7B, and 7C are block diagrams of a view across the example micromirror pixel 302 of FIG. 6D illustrating various tilt angles. As shown in FIG. 7A, a voltage V7 is applied to the mirror 602 and electrode 642, a voltage V8 is applied to the electrode 646, a voltage V9 is applied to the electrode 648, a voltage V10 is applied to the electrode 650, and a voltage V11 is applied to the electrode 652. Responsive to V7 having a first value, V8 having a second value, and V9 having a third value, a resulting electrostatic force between the mirror 602 and the electrode(s) 636, 638, 646, 648 causes the mirror 602 to tilt to an angle of Θ4 and come to rest on a spring tip (not shown) of the micromirror pixel 302. For example, as shown in FIG. 7A, the combination of values of V7, V8, and V9 causes an electrostatic force between the mirror 602 and the raised electrode 638 to increase to an amount greater than between the mirror 602 and the raised electrode 636. Accordingly, the mirror 602 tilts toward the raised electrode 638. In some examples, V7 has a value approximately equal to 21 V, V8 has a value approximately equal to 1.8 V, and V9 has a value approximately equal to 0 V.

As shown in FIG. 7B, responsive to a change in value of V10 and V11, a resulting electrostatic force between the mirror 602 and the electrode(s) 636, 638, 646, 648, 650, 652 causes the mirror 602 to tilt to an angle of Θ5, where Θ5>Θ4. For example, an electrostatic force between the mirror 602 and the electrode 652 increases, causing the tilt angle of the mirror 602 to increase in the direction of the electrode 652. The increased tilt angle of the mirror 602 in FIG. 7B results in increased deflection of a spring tip on which the mirror 602 rests. In some examples, the change in tilt angle of the mirror 602 to Θ5 occurs without a change to V7, V8, or V9. In some examples, V10 and V11 of FIG. 7B have a value of approximately −4 V.

As shown in FIG. 7C, responsive to a change in value of V10 and V11, a resulting electrostatic force between the mirror 602 and the electrode(s) 636, 638, 646, 648, 650, 652 causes the mirror 602 to tilt to an angle of Θ6, where Θ4>Θ6. For example, an electrostatic force between the mirror 602 and the electrode 652 decreases (e.g., the electrode 652 repels the mirror 602), causing the tilt angle of the mirror 602 to decrease. The decreased tilt angle of the mirror 602 in FIG. 7C results in increased sag of the hinge 606 to which the mirror 602 is coupled. In some examples, the change in tilt angle of the mirror to Θ6 occurs without a change to V7, V8, or V9. In some examples, V10 and V11 of FIG. 7C have a value greater than 0 V.

Although certain example voltages are described with respect to FIGS. 7A-7C, in application other voltages may be used. In some examples, performance of the micromirror pixel 302 may be measured and the voltages determined based on that measuring. For example, a variance of Θ5 from a nominal value for Θ5 may first be determined. Subsequently, various values of V10 and V11 may be tested to determine an effect on the tilt angle of the micromirror pixel 302 resulting from the various combinations of tested values of V10 and V11. Thus, a mapping may be determined between values of V10 and V11 and corresponding approximate tilt angles of the micromirror pixel 302. In some examples, Θ6 and Θ7 are within about 1 degree of Θ5. For example, Θ6 and Θ7 may be within about 0.5 degree of Θ5. Thus, in such an example, the tilt angle of the mirror 402 may be increased or decreased from Θ5 by approximately 0.5 degree based on values of bias voltages provided at the electrodes 650, 652.

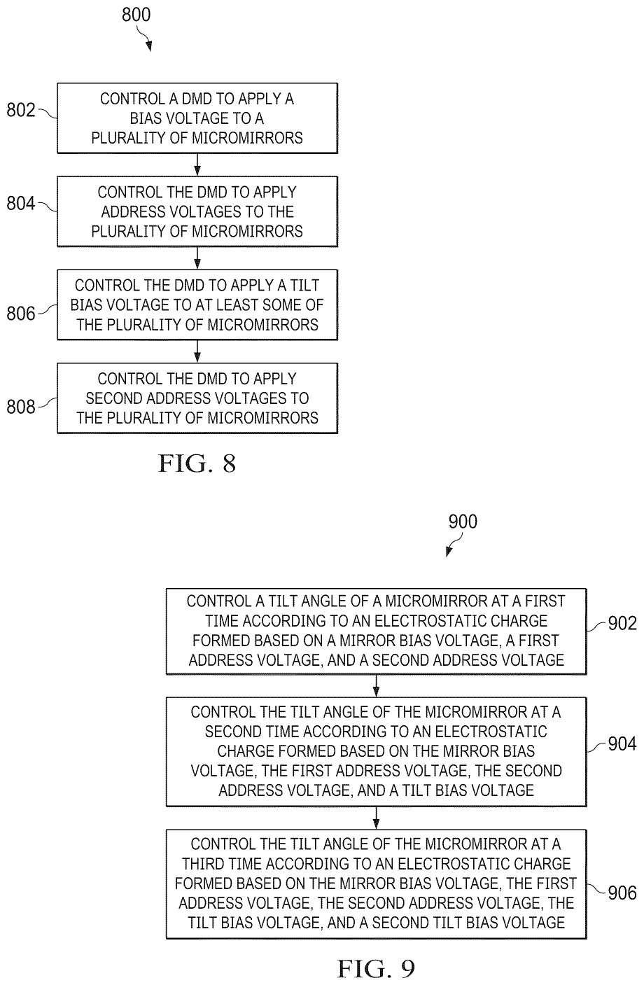

FIG. 8 is a flowchart of an example method 800 for control of a micromirror device. In some examples, the method 800 may be implemented by or in a system, such as the system 100. For example, the method 800 may be implemented in part by the controller 102 and/or in part by the DMD 110 to cause the DMD 110 to reflect light to create an image. In some examples, the operations of the method 800 are performed substantially in sequence. For example, operations 802 and 804 are performed before operations 806 and 808. In other examples, any one or more of the operations of the method 800 are performed substantially concurrently with any one or more other of the operations of the method 800.

At operation 802, the controller 102 controls the DMD 110 to apply a bias voltage to a plurality of micromirror pixels 302. The bias voltage may be a mirror bias voltage. In some examples, the bias voltage is approximately 21 V.

At operation 804, the controller 102 controls the DMD 110 to apply address voltages to the plurality of micromirror pixels 302. A particular value of an address voltage provided to a particular micromirror pixel 302 may depend on a nominal tilt angle for that respective micromirror pixel 302 and an image for display by the DMD 110. For example, a first set of the plurality of micromirror pixels 302 may be controlled to reflect light toward a lens for display as bright pixels on a projection surface while a second set of the plurality of micromirror pixels 302 may be controlled to reflect light away from the lens to cause corresponding dark pixels to appear on the projection surface to form a first image.

At operation 806, the controller 102 controls the DMD 110 to apply a tilt bias voltage to at least some of the micromirror pixels 302. In some examples, the tilt bias voltage is applied to one of the micromirror pixels 302. In other examples, the tilt bias voltage is applied to multiple of the micromirror pixels 302. The tilt bias voltage may cause the tilt angle of the micromirror pixels 302 receiving the tilt bias voltage to change without a corresponding change to the bias voltage or the address voltages. For example, the tilt bias voltage may cause the tilt angle of the micromirror pixel 302 receiving the tilt bias voltage to become increasing close to the nominal tilt angle for that respective micromirror pixel 302.

At operation 808, the controller 102 controls the DMD 110 to apply second address voltages to the plurality of micromirror pixels 302. A particular value of the second address voltages provided to a particular micromirror pixel 302 may depend on the nominal tilt angle for that respective micromirror pixel 302 and the image for display by the DMD 110. For example, a third set of the plurality of micromirror pixels 302 may be controlled to reflect light toward the lens for display as bright pixels on the projection surface while a fourth set of the plurality of micromirror pixels 302 may be controlled to reflect light away from the lens to cause corresponding dark pixels to appear on the projection surface to form a second image different from the first image.

FIG. 9 is a flowchart of an example method 900 for control of a micromirror device. In some examples, the method 900 may be implemented by or in a system, such as the system 100. For example, the method 900 may be implemented in part by the controller 102 and/or in part by the DMD 110 to cause the DMD 110 to reflect light to create an image.

At operation 902, a DMD controls a tilt angle of a micromirror device at a first time according to an electrostatic charge formed based on a mirror bias voltage, a first address voltage, and a second address voltage. For example, the DMD may control the tilt angle to cause the micromirror device to reflect light toward or away from a lens to cause a corresponding bright or dark pixel, respectively, on a projection surface.

At operation 904, the DMD controls the tilt angle of the micromirror device at a second time according to an electrostatic charge formed based on the mirror bias voltage, the first address voltage, the second address voltage, and a tilt bias voltage. In some examples, the tilt angle of the micromirror device at the second time is different from the tilt angle of the micromirror device at the first time and changes responsive to the tilt bias voltage without a change in value of the mirror bias voltage, the first address voltage, or the second address voltage.

At operation 906, the DMD controls the tilt angle of the micromirror device at a third time according to an electrostatic charge formed based on the mirror bias voltage, the first address voltage, the second address voltage, the tilt bias voltage, and a second tilt bias voltage. In some examples, the tilt angle of the micromirror device at the second time is different from the tilt angle of the micromirror device at the first time or the second time and changes responsive to the second tilt bias voltage without a change in value of the mirror bias voltage, the first address voltage, or the second address voltage.

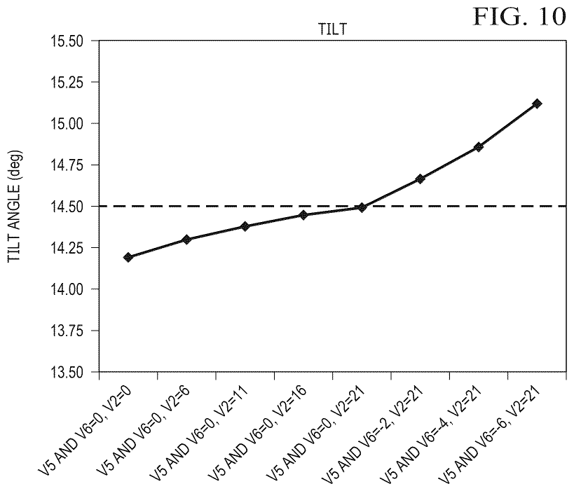

FIG. 10 is a diagram of tilt angles of an example micromirror pixel 302. In some examples, the tilt angles shown in FIG. 10 correspond to the micromirror pixel 302 as shown in FIGS. 4A-4D. Additionally, while particular example values are shown for tilt angles and their corresponding values of V2, V5, and V6, the present disclosure is not limited to these example values.

As shown in FIG. 10, a nominal tilt angle for the micromirror pixel 302 may be 14.5 degrees and occur for given values of V1, V3, and V4 when V2 is approximately equal to V1 (having a value of about 21 V) and both V5 and V6 have a value of approximately 0 V. The nominal tilt angle may be the tilt angle assumed by the micromirror pixel 302 for the given values of V1, V3, and V4 when V2 is approximately equal to V1 (having a value of about 21 V) and both V5 and V6 have a value of approximately 0 V irrespective of effects of variation in manufacturing process control and tolerances of the micromirror pixel 302. To increase the tilt angle, V5 and V6 are decreased in value from zero to become more negative, increasing a voltage differential between V1 and V5 or V6. Similarly, to decrease the tilt angle, V2 is decreased in value from being approximately equal to V1 to approach 0 V, increasing a voltage differential between V1 and V2.

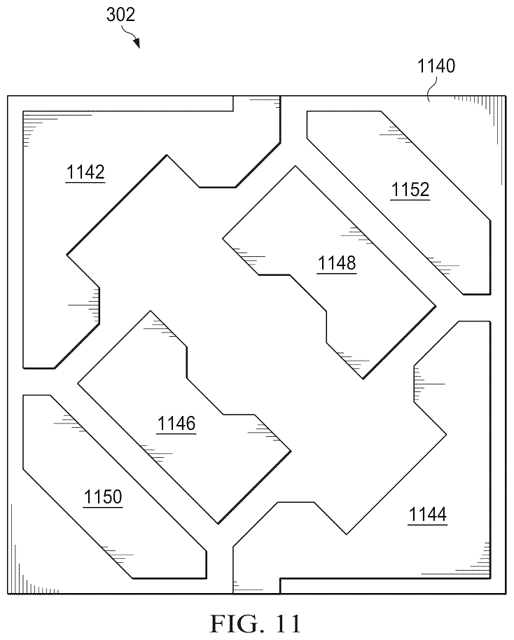

FIG. 11 is a top-down view of another example micromirror pixel 302. In some examples, the view of the micromirror pixel 302 as shown in FIG. 11 omits the mirror, vias, and hinge layer, such as described above with respect to FIGS. 4A-4D or FIGS. 6A-6D. The view of the micromirror pixel 302 as shown in FIG. 11 includes a substrate 1140 and electrodes 1142, 1144, 1146, 1148, 1150, and 1152 of the example micromirror pixel 302. In an example, the electrodes 1142, 1144 are mirror bias electrodes, the electrodes 1146, 1148 are address electrodes, and the electrodes 1150, 1152 are outer tilt bias electrode, such as described above with respect to FIGS. 4A-4D. Generally, the micromirror pixel 302 functions substantially the same as the micromirror pixel 302 of FIGS. 4A-4D with the omission of the electrode 454 such that tilt biasing may be performed by way of the electrodes 1150, 1152. Accordingly, such description is not repeated herein. Similarly, the electrodes 1142, 1144, 1146, 1148, 1150, and 1152 of the micromirror pixel 302 of FIG. 11 includes couplings to vias, raised electrodes, a hinge, and a mirror (each not shown) that are substantially the same as the micromirror pixel 302 of FIGS. 4A-4D with the omission of the electrode 454. Accordingly, such description is not repeated herein.

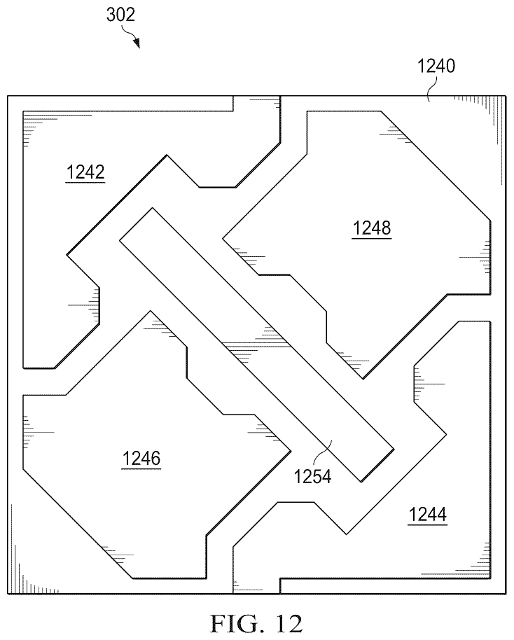

FIG. 12 is a top-down view of another example micromirror pixel 302. In some examples, the view of the micromirror pixel 302 as shown in FIG. 12 omits the mirror, vias, and hinge layer, such as described above with respect to FIGS. 4A-4D or FIGS. 6A-6D. The view of the micromirror pixel 302 as shown in FIG. 12 includes a substrate 1240 and electrodes 1242, 1244, 1246, 1248, and 1254 of the example micromirror pixel 302. In an example, the electrodes 1242, 1244 are mirror bias electrodes, the electrodes 1246, 1248 are address electrodes, and the electrode 1254 is an inner tilt bias electrode, such as described above with respect to FIGS. 4A-4D. Generally, the micromirror pixel 302 functions substantially the same as the micromirror pixel 302 of FIGS. 4A-4D with the omission of the electrodes 450, 452 such that tilt biasing may be performed by way of the electrode 1254. Accordingly, such description is not repeated herein. Similarly, the electrodes 1242, 1244, 1246, 1248, and 1254 of the micromirror pixel 302 of FIG. 12 includes couplings to vias, raised electrodes, a hinge, and a mirror (each not shown) that are substantially the same as the micromirror pixel 302 of FIGS. 4A-4D with the omission of the electrodes 450, 452. Accordingly, such description is not repeated herein.

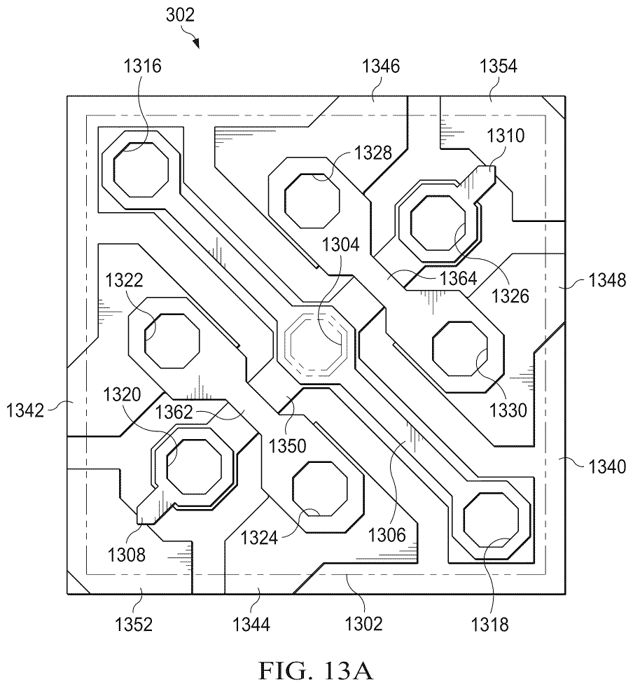

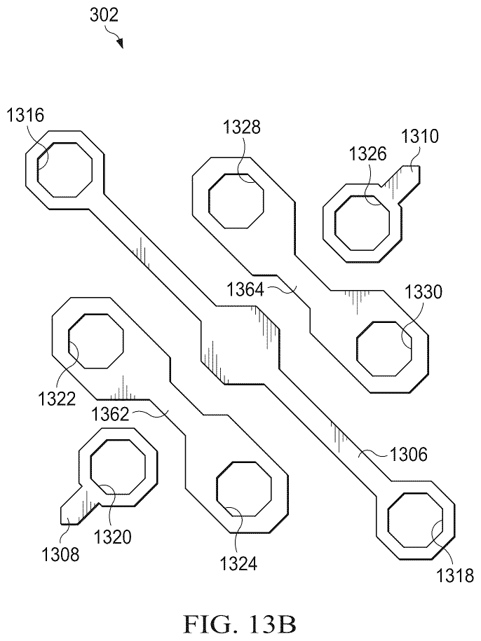

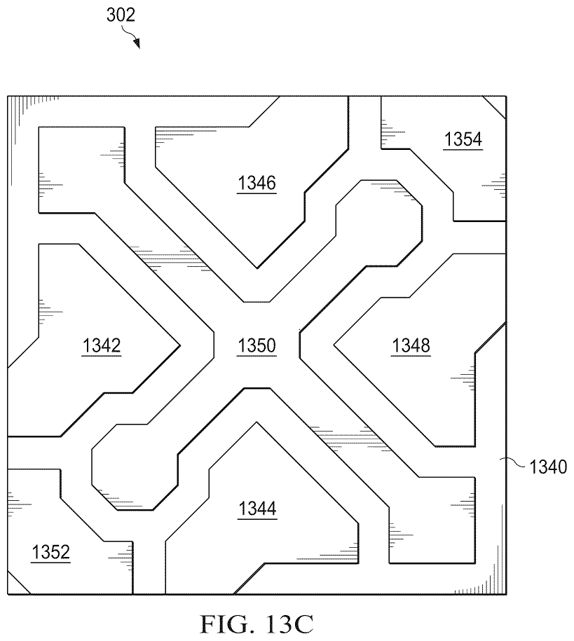

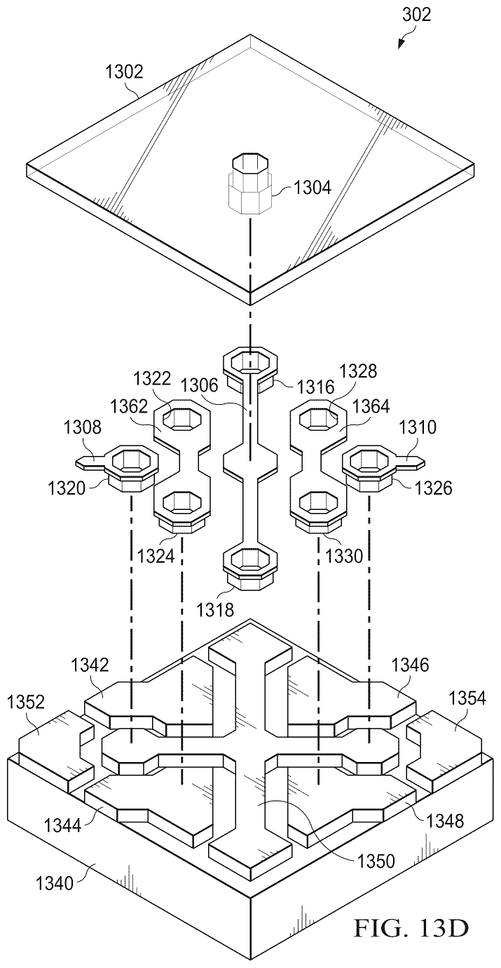

In some examples, the micromirror pixel 302 may take other forms, such as a single spring tip design or a cantilever hinge design. FIG. 13A is a top-down view of another example micromirror pixel 302. FIG. 13B is a top-down view of a hinge layer of the example micromirror pixel 302 of FIG. 13A, and FIG. 13C is a top-down view of an electrode layer and substrate of the example micromirror pixel 302 of FIG. 13A. FIG. 13D is an exploded view of the example micromirror pixel 302 of FIG. 13A. In an example, the micromirror pixel 302 of FIGS. 13A, 13B, 13C, 13D is a single spring tip design micromirror pixel having outer tilt bias electrodes.

The micromirror pixel 302 of FIG. 13A includes a mirror 1302, a hinge layer (as shown isolated in FIG. 13B) including hinge 1306 and spring tips 1308, 1310 a via layer (which may be included as a part of the hinge layer, in some examples) including vias 1316, 1318, 1320, 1322, 1324, 1326, 1328, 1330, and a substrate 1340 upon which an electrode layer is disposed including electrodes 1342, 1344, 1346, 1348, 1350, 1352, 1354. In some examples, electrodes 1342 and 1344 have a corresponding raised electrode 1362 and electrodes 1346 and 1348 have a corresponding raised electrode 1364. In an example, the hinge layer includes the raised electrodes 1362 and 1364 The mirror 1302 is mechanically and electrically coupled to the hinge 1306 through a via 1304. In some examples, the hinge 1306 may be a torsion hinge such that the mirror 1302 may tilt or rotate about a center axis of the hinge 1306 running lengthwise through the hinge 1306. The hinge 1306 is mechanically and electrically coupled to the electrode 1350 through the vias 1316, 1318. Thus, the mirror 1302 may be mechanically and electrically coupled to the electrode 1350 by way of the via 1304, hinge 1306, and vias 1316, 1318. The raised electrode 1362 is mechanically and electrically coupled to the electrode 1342 through via 1322 and to the electrode 1344 through via 1324. The raised electrode 1364 is mechanically and electrically coupled to the electrode 1346 through via 1328 and to the electrode 1348 through the via 1330. In some examples, the substrate 1340 includes CMOS circuitry, such as memory (e.g., SRAM) cells for a respective micromirror pixel. While certain shapes for the electrodes 1342, 1344, 1346, 1348, 1350, 1352, 1354 are shown in FIGS. 13A, 13C, the electrodes may have other shapes in other examples. A positioning of the electrodes 1342, 1344, 1346, 1348, 1350, 1352, 1354 with respect to one another is shown in FIG. 13C.

In an example, the electrode 1350 may be referred to as a mirror bias electrode. The electrode 1350 may be energized to provide a bias voltage at the mirror 1302 and spring tips 1308, 1310. In some examples, the bias voltage may be about 21 V. The electrodes 1342, 1344, 1346, and 1348 may be referred to as address electrodes, where the electrodes 1342, 1344 together form a first address electrode (e.g., receive a same first address voltage) and the electrodes 1346, 1348 together form a second address electrode (e.g., receive a same second address voltage). The electrodes 1342, 1344, 1346, and 1348 may be energized, or de-energized, to provide address voltages. The address voltages may correspond to particular programmed or nominal tilt angles for the mirror 1302 corresponding to those particular address voltages. In some examples, the address voltages provided to the electrode first address electrode (e.g., the electrodes 1342, 1344) and the second address electrode (e.g., the electrodes 1346, 1348) may be complementary voltages. The electrodes 1352, 1354 may be referred to as outer tilt bias electrodes. The electrodes 1352, 1354 may be energized, or de-energized, to increase or decrease the tilt angle of the mirror 1302. For example, an increased tilt angle of the mirror 1302 results in increased spring tip deflection by one of the spring tips 1308, 1310 in a direction to which the mirror 1302 is tilting and a decreased tile angle of the mirror 1302 results in increase hinge sag of the hinge 1306. In some examples, such increase or decrease occurs without a corresponding change to the bias voltage provided at the mirror 1302 or the address voltages. As a voltage differential between a value of the bias voltage provided at the mirror 1302 and a respective electrode of the micromirror pixel 302 increases, the mirror 1302 may be drawn via electrostatic attraction toward that respective electrode. By way of the hinge 1306 and spring tips 1308, 1310, this electrostatic attraction causes the mirror 1302 to tilt in the direction of the respective electrode to which the mirror 1302 is being drawn, coming to rest against a respective spring tip 1308, 1310. Generally, operation of the micromirror pixel 302 of FIG. 13A with respect to tilting of the mirror 1302 may be similar to that of the micromirror pixel 302 of FIG. 6A with respect to tilting of the mirror 602. Accordingly, such description is not repeated in detail again with respect to FIGS. 13A-13C.

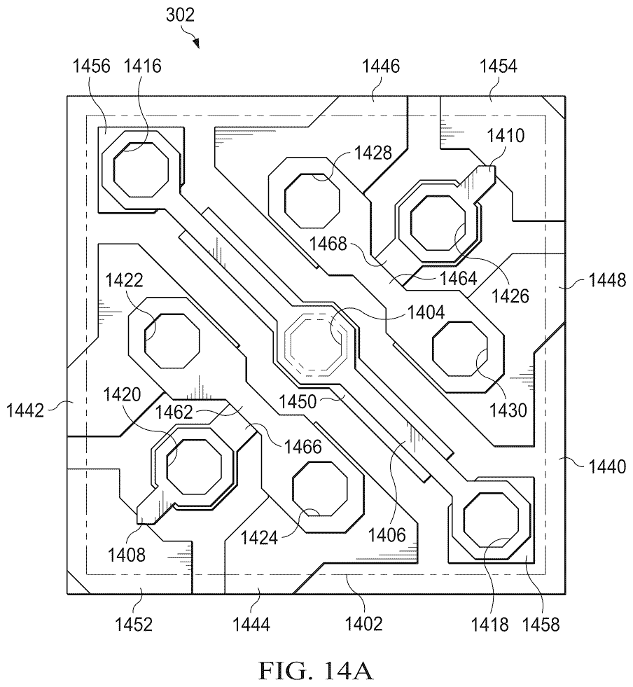

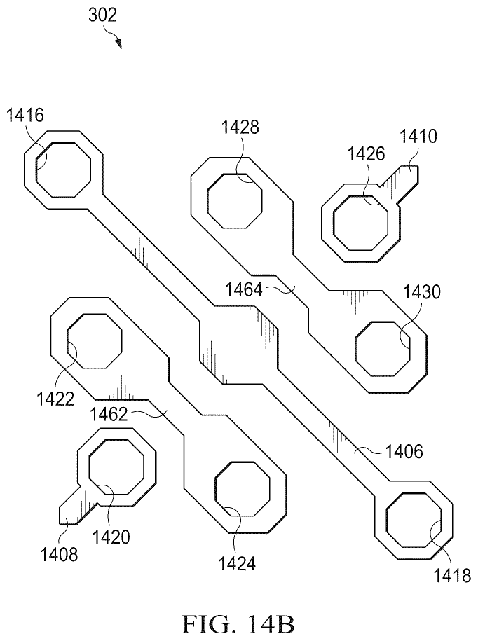

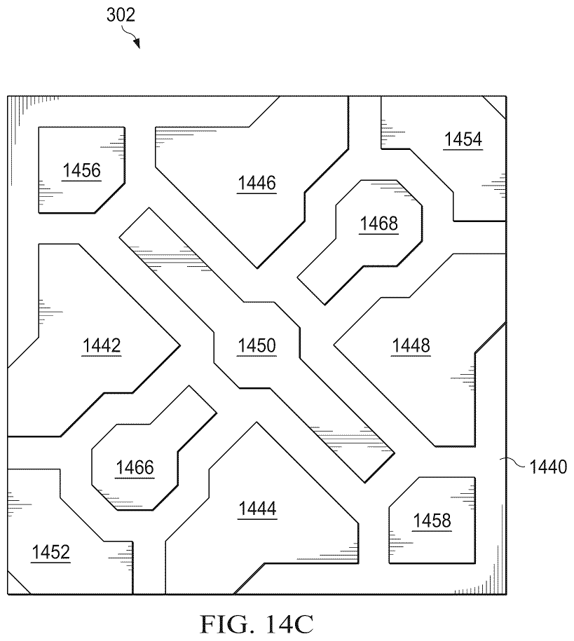

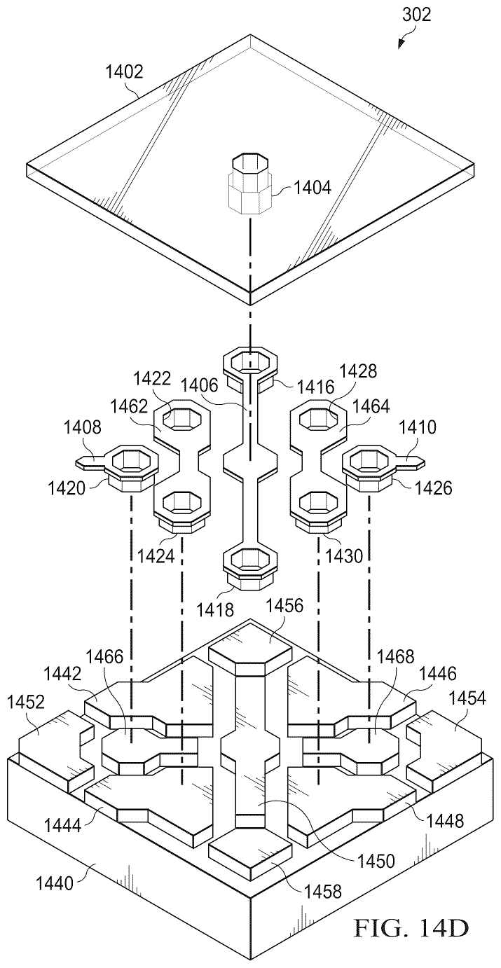

FIG. 14A is a top-down view of another example micromirror pixel 302. FIG. 14B is a top-down view of a hinge layer of the example micromirror pixel 302 of FIG. 14A, and FIG. 14C is a top-down view of an electrode layer and substrate of the example micromirror pixel 302 of FIG. 14A. FIG. 14D is an exploded view of the example micromirror pixel 302 of FIG. 14A. In an example, the micromirror pixel 302 of FIGS. 14A, 14B, 14C, 14D is a single spring tip design micromirror pixel having inner and outer tilt bias electrodes.

The micromirror pixel 302 of FIG. 14A includes a mirror 1402, a hinge layer (as shown isolated in FIG. 14B) including hinge 1406 and spring tips 1408, 1410 a via layer (which may be included as a part of the hinge layer, in some examples) including vias 1416, 1418, 1420, 1422, 1424, 1426, 1428, 1430, and a substrate 1440 upon which an electrode layer is disposed including electrodes 1442, 1444, 1446, 1448, 1450, 1452, 1454, 1456, 1458, 1466, 1468. In some examples, electrodes 1442 and 1444 have a corresponding raised electrode 1462 and electrodes 1446 and 1448 have a corresponding raised electrode 1464. In an example, the hinge layer includes the raised electrodes 1462 and 1464 The mirror 1402 is mechanically and electrically coupled to the hinge 1406 through a via 1404. In some examples, the hinge 1406 may be a torsion hinge such that the mirror 1402 may tilt or rotate about a center axis of the hinge 1406 running lengthwise through the hinge 1406. The hinge 1406 is mechanically and electrically coupled to the electrodes 1456, 1458 through the vias 1416, 1418. Thus, the mirror 1402 may be mechanically and electrically coupled to the electrodes 1456, 1458 by way of the via 1404, hinge 1406, and vias 1416, 1418. The raised electrode 1462 is mechanically and electrically coupled to the electrode 1442 through via 1422 and to the electrode 1444 through via 1424. The raised electrode 1464 is mechanically and electrically coupled to the electrode 1446 through via 1428 and to the electrode 1448 through the via 1430. In some examples, the substrate 1440 includes CMOS circuitry, such as memory (e.g., SRAM) cells for a respective micromirror pixel. While certain shapes for the electrodes 1442, 1444, 1446, 1448, 1450, 1452, 1454, 1456, 1458, 1466, 1468 are shown in FIGS. 14A, 14C, the electrodes may have other shapes in other examples. A positioning of the electrodes 1442, 1444, 1446, 1448, 1450, 1452, 1454, 1456, 1458, 1466, 1468 with respect to one another is shown in FIG. 14C.

In an example, the electrodes 1456, 1458, 1466, 1468 may be referred to as mirror bias electrodes. The electrodes 1456, 1458, 1466, 1468 may be energized to provide a bias voltage at the mirror 1402 and spring tips 1408, 1410. In some examples, the bias voltage may be about 21 V. The electrodes 1442, 1444, 1446, and 1448 may be referred to as address electrodes, where the electrodes 1442, 1444 together form a first address electrode (e.g., receive a same first address voltage) and the electrodes 1446, 1448 together form a second address electrode (e.g., receive a same second address voltage). The electrodes 1442, 1444, 1446, and 1448 may be energized, or de-energized, to provide address voltages. The address voltages may correspond to particular programmed or nominal tilt angles for the mirror 1402 corresponding to those particular address voltages. In some examples, the address voltages provided to the electrode first address electrode (e.g., the electrodes 1442, 1444) and the second address electrode (e.g., the electrodes 1446, 1448) may be complementary voltages. The electrodes 1452, 1454 may be referred to as outer tilt bias electrodes. The electrodes 1452, 1454 may be energized, or de-energized, to increase or decrease the tilt angle of the mirror 1402. For example, an increased tilt angle of the mirror 1402 results in increased spring tip deflection by one of the spring tips 1408, 1410 in a direction to which the mirror 1402 is tilting and a decreased tile angle of the mirror 1402 results in increase hinge sag of the hinge 1406. In some examples, such increase or decrease occurs without a corresponding change to the bias voltage provided at the mirror 1402 or the address voltages. The electrode 1450 may be referred to as an inner tilt bias electrode or inner electrode. The electrode 1450 may be energized, or de-energized, to increase or decrease the tilt angle of the mirror 1402. In some examples, such increase or decrease occurs without a corresponding change to the bias voltage provided at the mirror 1402 or the address voltages. As a voltage differential between a value of the bias voltage provided at the mirror 1402 and a respective electrode of the micromirror pixel 302 increases, the mirror 1402 may be drawn via electrostatic attraction toward that respective electrode. By way of the hinge 1406 and spring tips 1408, 1410, this electrostatic attraction causes the mirror 1402 to tilt in the direction of the respective electrode to which the mirror 1402 is being drawn, coming to rest against a respective spring tip 1408, 1410. Generally, operation of the micromirror pixel 302 of FIG. 14A with respect to tilting of the mirror 1402 may be similar to that of the micromirror pixel 302 of FIG. 4A with respect to tilting of the mirror 402. Accordingly, such description is not repeated in detail again with respect to FIGS. 14A-14C.

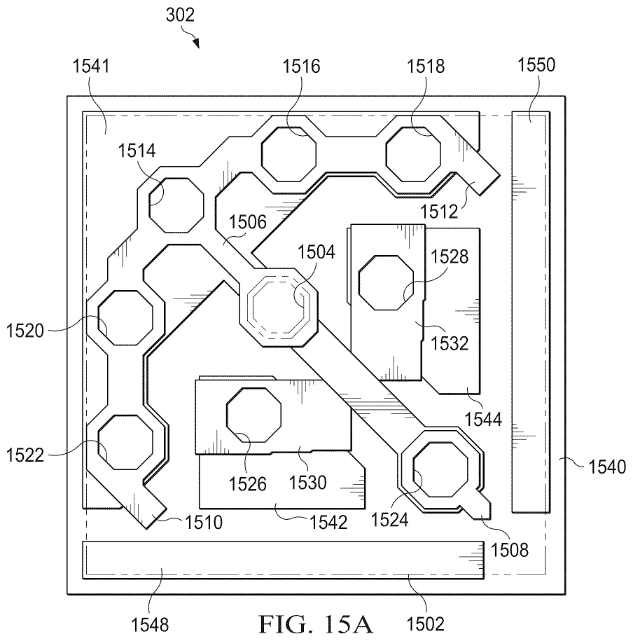

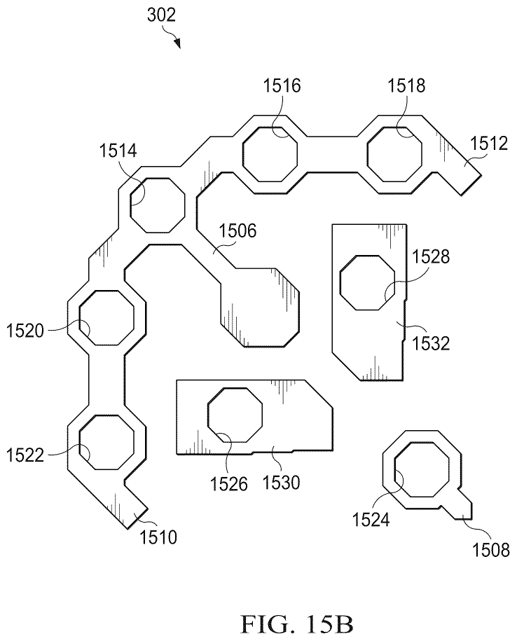

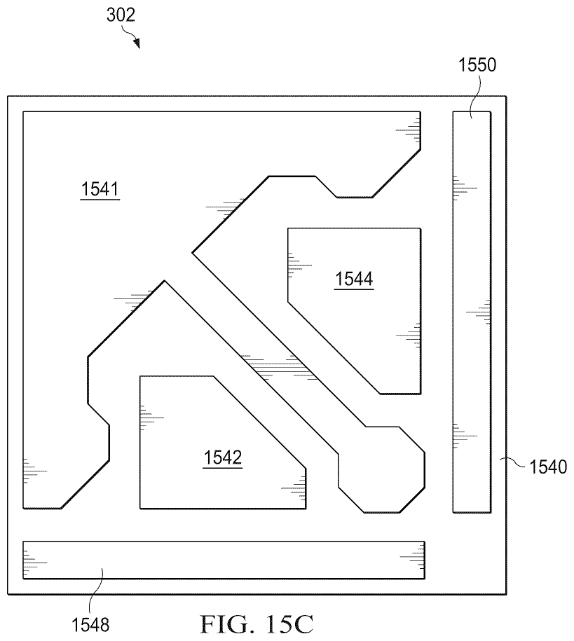

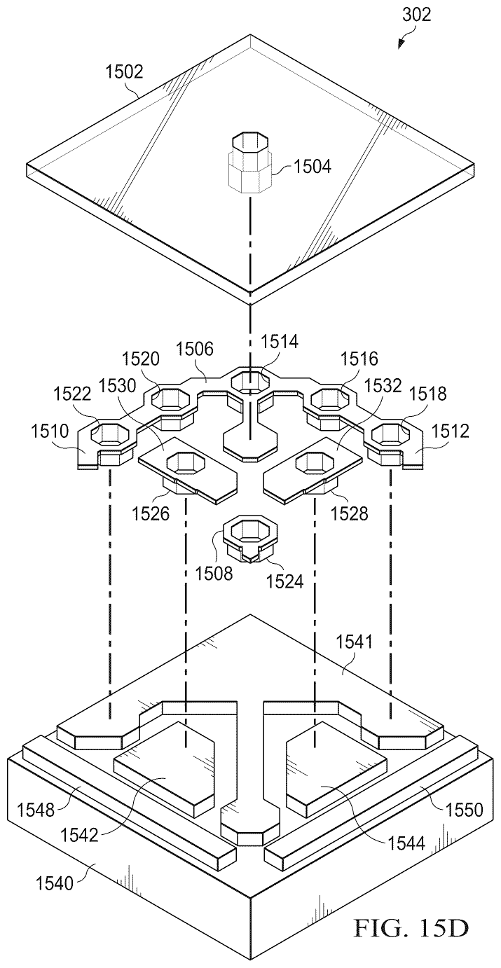

FIG. 15A is a top-down view of another example micromirror pixel 302. FIG. 15B is a top-down view of a hinge layer of the example micromirror pixel 302 of FIG. 15A, and FIG. 15C is a top-down view of an electrode layer and substrate of the example micromirror pixel 302 of FIG. 15A. FIG. 15D is an exploded view of the example micromirror pixel 302 of FIG. 15A. In an example, the micromirror pixel 302 of FIGS. 15A, 15B, 15C, 15D is a cantilever hinge design micromirror pixel having outer tilt bias electrodes.

The micromirror pixel 302 of FIG. 15A includes a mirror 1502, a hinge layer (as shown isolated in FIG. 15B) including hinge 1506 and spring tips 1508, 1510, 1512, a via layer (which may be included as a part of the hinge layer, in some examples) including vias 1514, 1516, 1518, 1520, 1522, 1524, 1526, 1528, and a substrate 1540 upon which an electrode layer is disposed including electrodes 1541, 1542, 1544, 1546, 1548, 1550. In some examples, electrodes 1542 and 1544 have corresponding raised electrodes 1530, 1532, respectively. In an example, the hinge layer includes the raised electrodes 1530, 1532. The mirror 1502 is mechanically and electrically coupled to the hinge 1506 through a via 1504. In some examples, the hinge 1506 may be a cantilever hinge. The hinge 1506 is mechanically and electrically coupled to the electrode 1541 through the vias 1514, 1516, 1518, 1520, 1522. Thus, the mirror 1502 may be mechanically and electrically coupled to the electrode 1541 by way of the via 1504, hinge 1506, and vias 1514, 1516, 1518, 1520, 1522. The raised electrode 1530 is mechanically and electrically coupled to the electrode 1542 through via 1526. The raised electrode 1532 is mechanically and electrically coupled to the electrode 1544 through via 1528. In some examples, the substrate 1540 includes CMOS circuitry, such as memory (e.g., SRAM) cells for a respective micromirror pixel. While certain shapes for the electrodes 1541, 1542, 1544, 1546, 1548, 1550 are shown in FIGS. 15A, 15C, the electrodes may have other shapes in other examples. A positioning of the electrodes 1541, 1542, 1544, 1546, 1548, 1550 with respect to one another is shown in FIG. 15C.

In an example, the electrode 1541 may be referred to as a mirror bias electrode. The electrode 1541 may be energized to provide a bias voltage at the mirror 1502 and spring tips 1508, 1510, 1512. In some examples, the bias voltage may be about 21 V. The electrodes 1542, 1544 may be referred to as address electrodes. The electrodes 1542, 1544 may be energized, or de-energized, to provide address voltages. The address voltages may correspond to particular programmed or nominal tilt angles for the mirror 1502 corresponding to those particular address voltages. In some examples, the address voltages may be complementary voltages. The electrodes 1548, 1550 may be referred to as outer tilt bias electrodes. The electrodes 1548, 1550 may be energized, or de-energized, to increase or decrease the tilt angle of the mirror 1502. For example, an increased tilt angle of the mirror 1502 results in increased spring tip deflection by one of the spring tips 1508, 1510, 1512 in a direction to which the mirror 1502 is tilting and a decreased tile angle of the mirror 1502 results in increase hinge sag of the hinge 1506. In some examples, such increase or decrease occurs without a corresponding change to the bias voltage provided at the mirror 1502 or the address voltages. As a voltage differential between a value of the bias voltage provided at the mirror 1502 and a respective electrode of the micromirror pixel 302 increases, the mirror 1502 may be drawn via electrostatic attraction toward that respective electrode. By way of the hinge 1506 and spring tips 1508, 1510, 1512, this electrostatic attraction causes the mirror 1502 to tilt in the direction of the respective electrode to which the mirror 1502 is being drawn, coming to rest against a respective spring tip 1508, 1510, 1512. Generally, operation of the micromirror pixel 302 of FIG. 15A with respect to increasing or decreasing tilting of the mirror 1502 via outer tilt bias electrodes may be similar to that of the preceding examples of the micromirror pixel 302 described above herein. Accordingly, such description is not repeated in detail again with respect to FIGS. 15A-15C.

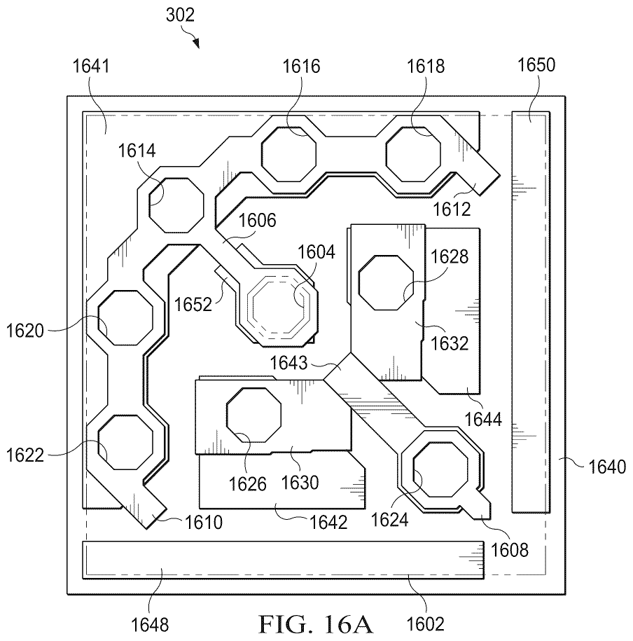

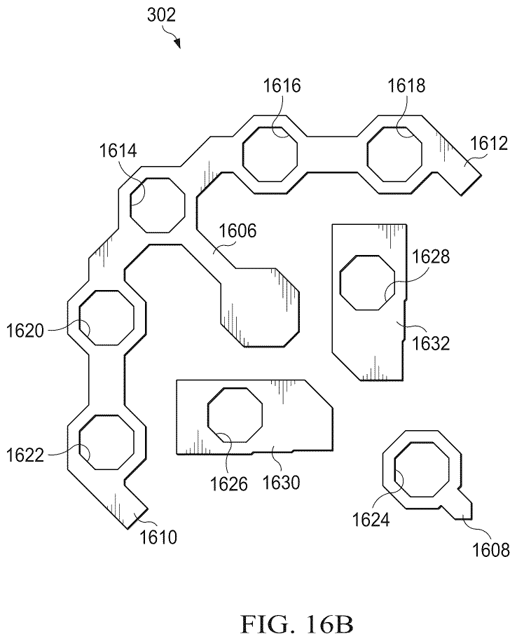

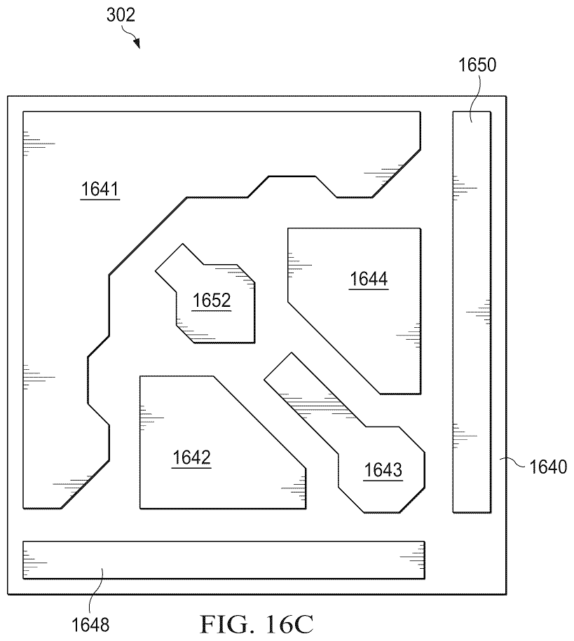

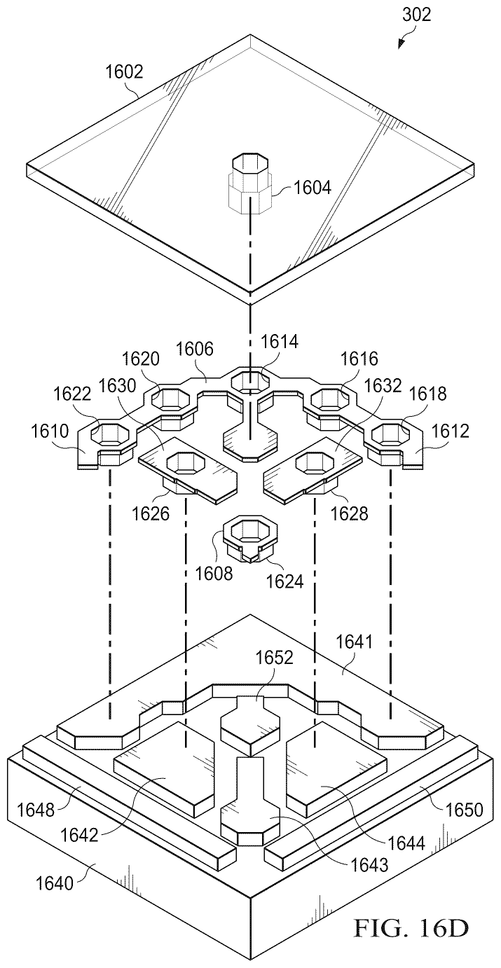

FIG. 16A is a top-down view of another example micromirror pixel 302. FIG. 16B is a top-down view of a hinge layer of the example micromirror pixel 302 of FIG. 16A, and FIG. 16C is a top-down view of an electrode layer and substrate of the example micromirror pixel 302 of FIG. 16A. FIG. 16D is an exploded view of the example micromirror pixel 302 of FIG. 16A. In an example, the micromirror pixel 302 of FIGS. 16A, 16B, 16C, 16D is a cantilever hinge design micromirror pixel having inner and outer tilt bias electrodes.

The micromirror pixel 302 of FIG. 16A includes a mirror 1602, a hinge layer (as shown isolated in FIG. 16B) including hinge 1606 and spring tips 1608, 1610, 1612, a via layer (which may be included as a part of the hinge layer, in some examples) including vias 1614, 1616, 1618, 1620, 1622, 1624, 1626, 1628, and a substrate 1640 upon which an electrode layer is disposed including electrodes 1641, 1642, 1643, 1644, 1646, 1648, 1650, 1652. In some examples, electrodes 1642 and 1644 have corresponding raised electrodes 1630, 1632, respectively. In an example, the hinge layer includes the raised electrodes 1630, 1632. The mirror 1602 is mechanically and electrically coupled to the hinge 1606 through a via 1604. In some examples, the hinge 1606 may be a cantilever hinge. The hinge 1606 is mechanically and electrically coupled to the electrode 1641 through the vias 1614, 1616, 1618, 1620, 1622. Thus, the mirror 1602 may be mechanically and electrically coupled to the electrode 1641 by way of the via 1604, hinge 1606, and vias 1614, 1616, 1618, 1620, 1622. The raised electrode 1630 is mechanically and electrically coupled to the electrode 1642 through via 1626. The raised electrode 1632 is mechanically and electrically coupled to the electrode 1644 through via 1628. The spring tip 1608 is coupled to the electrode 1643 through the via 1624. In some examples, the substrate 1640 includes CMOS circuitry, such as memory (e.g., SRAM) cells for a respective micromirror pixel. While certain shapes for the electrodes 1641, 1642, 1643, 1644, 1646, 1648, 1650, 1652 are shown in FIGS. 16A, 16C, the electrodes may have other shapes in other examples. A positioning of the electrodes 1641, 1642, 1643, 1644, 1646, 1648, 1650, 1652 with respect to one another is shown in FIG. 16C.

In an example, the electrodes 1641, 1643 may be referred to as mirror bias electrodes. The electrodes 1641, 1643 may be energized to provide a bias voltage at the mirror 1602 and spring tip 1612. In some examples, the bias voltage may be about 21 V. The electrodes 1642, 1644 may be referred to as address electrodes. The electrodes 1642, 1644 may be energized, or de-energized, to provide address voltages. The address voltages may correspond to particular programmed or nominal tilt angles for the mirror 1602 corresponding to those particular address voltages. In some examples, the address voltages may be complementary voltages. The electrodes 1648, 1650 may be referred to as outer tilt bias electrodes. The electrodes 1648, 1650 may be energized, or de-energized, to increase or decrease the tilt angle of the mirror 1602. For example, an increased tilt angle of the mirror 1602 results in increased spring tip deflection by one of the spring tips 1608, 1610, 1612 in a direction to which the mirror 1602 is tilting and a decreased tile angle of the mirror 1602 results in increase hinge sag of the hinge 1606. In some examples, such increase or decrease occurs without a corresponding change to the bias voltage provided at the mirror 1602 or the address voltages. The electrode 1652 may be referred to as an inner tilt bias electrode or inner electrode. The electrode 1652 may be energized, or de-energized, to increase or decrease the tilt angle of the mirror 1602. In some examples, such increase or decrease occurs without a corresponding change to the bias voltage provided at the mirror 1602 or the address voltages. As a voltage differential between a value of the bias voltage provided at the mirror 1602 and a respective electrode of the micromirror pixel 302 increases, the mirror 1602 may be drawn via electrostatic attraction toward that respective electrode. By way of the hinge 1606 and spring tips 1608, 1610, 1612, this electrostatic attraction causes the mirror 1602 to tilt in the direction of the respective electrode to which the mirror 1602 is being drawn, coming to rest against a respective spring tip 1608, 1610, 1612. Generally, operation of the micromirror pixel 302 of FIG. 16A with respect to increasing or decreasing tilting of the mirror 1602 via outer tilt bias electrodes may be similar to that of the preceding examples of the micromirror pixel 302 described above herein. Accordingly, such description is not repeated in detail again with respect to FIGS. 16A-16C.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A by way of the control signal generated by device A.

While certain components may be described herein as being of a particular process technology, these components may be exchanged for components of other process technologies.

Unless otherwise stated, “about,” “approximately,” or “substantially” preceding a value means +/−10 percent of the stated value. Modifications are possible in the described examples, and other examples are possible within the scope of the claims.

What is claimed is:

1. A device, comprising:
a mirror;
first and second mirror bias electrodes on a substrate, the mirror electrically coupled to the first and second mirror bias electrodes;
first and second address electrodes on the substrate between the first and second mirror bias electrodes; and
first and second outer tilt bias electrodes on the substrate, the first and second address electrodes between the first and second outer tilt bias electrodes.

2. The device of claim 1, further comprising:
a hinge;
a first via coupling the mirror to the hinge;
a second via coupling the hinge to the first mirror bias electrode; and
a third via coupling the hinge to the second mirror bias electrode.

3. The device of claim 1, further comprising:
a first raised electrode;
a fourth via coupling the first raised electrode to the first address electrode;
a second raised electrode; and
a fifth via coupling the second raised electrode to the second address electrode.

4. The device of claim 1, wherein the device is configured to apply complementary voltages to the first and second address electrodes to tilt the mirror to a tilt angle based on an electrostatic charge existing between the mirror and the first and second address electrodes.

5. The device of claim 4, wherein the device is configured to increase the tilt angle responsive to receiving a voltage at the first and second outer tilt bias electrodes.

6. The device of claim 4, wherein the device is configured to decrease the tilt angle responsive to receiving a second voltage at the first and second outer tilt bias electrodes.

7. The device of claim 1, further comprising an inner electrode coupled to the first and second mirror bias electrodes, the inner electrode on the substrate between the first and second address electrodes.

8. A device, comprising:
a mirror;
first and second mirror bias electrodes on a substrate, the mirror coupled to the first and second mirror bias electrodes, and the first and second mirror bias electrodes configured to provide a mirror bias voltage to the mirror;
an inner bias electrode on the substrate between the first and second mirror bias electrodes, the inner bias electrode configured to receive a bias voltage; and
first and second address electrodes on the substrate between the first and second mirror bias electrodes, the first and second address electrodes configured to receive first and second respective address voltages to modify an electrostatic force between the mirror and the first and second address electrodes to cause the mirror to tilt to a tilt angle, wherein the inner bias electrode is on the substrate between the first and second address electrodes.

9. The device of claim 8, further comprising:
a hinge;
a first via coupling the mirror to the hinge;
a second via coupling the hinge to the first mirror bias electrode; and
a third via coupling the hinge to the second mirror bias electrode.

10. The device of claim 8, further comprising:
a first raised electrode;
a fourth via coupling the first raised electrode to the first address electrode;
a second raised electrode; and
a fifth via coupling the second raised electrode to the second address electrode.

11. The device of claim 8, wherein the device is configured to apply complementary voltages to the first and second address electrodes to tilt the mirror to a tilt angle based on an electrostatic charge existing between the mirror and the first and second address electrodes.

12. The device of claim 11, wherein the device is configured to decrease the tilt angle responsive to receiving a third voltage at the inner bias electrode.

13. The device of claim 11, wherein the device is configured to increase the tilt angle responsive to receiving a fourth voltage provided at the inner bias electrode.

14. The device of claim 8, wherein the inner bias electrode is electrically isolated from the first and second mirror bias electrodes.

15. The device of claim 8, further comprising first and second outer tilt bias electrodes disposed on the substrate, the first and second address electrodes disposed between the first and second outer tilt bias electrodes.

16. A device, comprising:
a substrate;
an electrode layer on the substrate, the electrode layer comprising:
a first electrode;
a second electrode;
a third electrode between the first electrode and the second electrode;
a fourth electrode between the first electrode and the second electrode;
a fifth electrode; and
a sixth electrode, wherein the third electrode and the fourth electrode are between the fifth electrode and the sixth electrode;
a via layer comprising:
a first via on the first electrode;
a second via on the second electrode;
a third via on the third electrode; and
a fourth via on the fourth electrode;
a hinge layer comprising:
a hinge on the first via and the second via;
a first raised electrode on the third via; and
a second raised electrode on the fourth via;
a mirror; and
a fifth via coupling the mirror and the hinge.

17. The device of claim 16, wherein the electrode layer further comprises a seventh electrode between the third electrode and the fourth electrode.

18. The device of claim 17, wherein the seventh electrode is coupled to the first electrode and the second electrode.

19. The device of claim 17, wherein the seventh electrode is electrically separated from the first electrode and the second electrode.

20. The device of claim 17, wherein the seventh electrode is beneath the hinge.
